(19) United States
(12) Patent Application Publication
(10) Pub. No.: US 2010/0288087 A1
(43) Pub. Date: Nov. 18, 2010

(54) TOOL HANDLE

(76) Inventor: Jin-Tsai Lai, Taichung-city (TW)

Correspondence Address: Chien-Hui Su, P. O. Box 70-121 Taichung, Taichung City, 40899, TW

(21) Appl. No.: 12/467,312

(22) Filed: May 18, 2009

(51) Int. Cl. B25G 1/08

(52) U.S. Cl. 81/490

(57) ABSTRACT

A tool handle includes a handle and a tool bit receiving assembly. The handle has a driving end disposed in one end thereof for adapting to connect to a tool bit. The handle has a receiving space defined in one end thereof and opposite to the driving end. The tool bit receiving assembly is rotatably received in the receiving space. The tool bit receiving assembly includes a cover and a base detachably connected to the cover. The base has multiple plug recesses defined therein for receiving multiple tool bits.

### BACKGROUND OF THE INVENTION

1. Field of the Invention

The present invention relates to a tool handle, and more particularly to a tool handle for receiving multiple tool bits.

2. Description of Related Art

A conventional tool handle in accordance with the prior art comprises a handle and a driving shank connected to the handle. The driving shank has a polygon recess defined therein for receiving a tool bit. When screwing a different fastener, user has to replace the tool bit. The tool bits are received in a tool box. Therefore, user has to carry the heavy tool box. It is not efficient and practical for user to carry the tool box. Furthermore, the volume of the tool bits is compact. The tool bits are easy to lose.

The present invention has arisen to mitigate and/or obviate the disadvantages of the conventional tool handle.

### SUMMARY OF THE INVENTION

The main objective of the present invention is to provide an improved tool handle for receiving multiple tool bits.

To achieve the objective, the tool handle includes a handle and a tool bit receiving assembly. The handle has a driving end disposed in one end thereof for adapting to connect to a tool bit. The handle has a receiving space defined in one end thereof and opposite to the driving end. The tool bit receiving assembly is rotatably received in the receiving space. The tool bit receiving assembly includes a cover and a base detachably connected to the cover. The base has multiple plug recesses defined therein for receiving multiple tool bits.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a tool handle in accordance with the present invention;

FIG. 2 is an assembled perspective view of the tool handle in accordance with the present invention;

FIG. 3 is a front elevation view of the tool handle in accordance with the present invention;

FIG. 4 is an operational perspective view of the tool handle, showing that the tool bit receiving assembly is turned over;

FIG. 5 is a front elevation view of the tool handle in FIG. 4;

FIG. 6a is an operational front elevation view of the tool handle, showing that the resilient arms are pressed;

FIG. 6b is an enlarged partial view in FIG. 6a;

FIG. 7 is an operational perspective view of the tool handle, showing that the tool bit receiving assembly is detached from the handle; and

FIG. 8 shows the operation of tool handle when screwing a fastener.

### DETAILED DESCRIPTION OF THE INVENTION

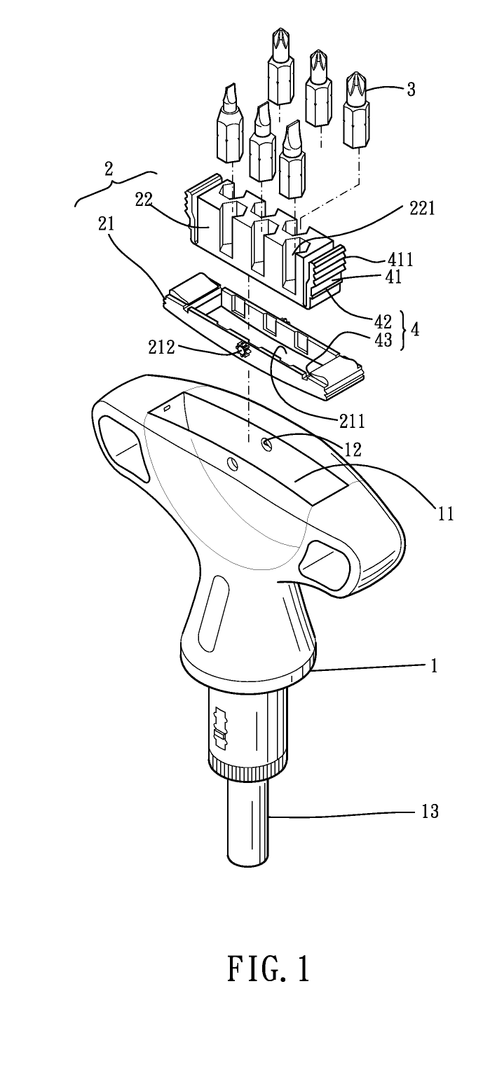

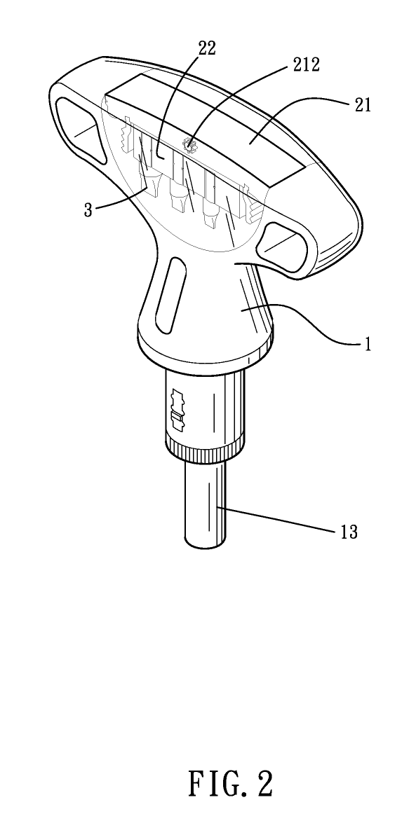

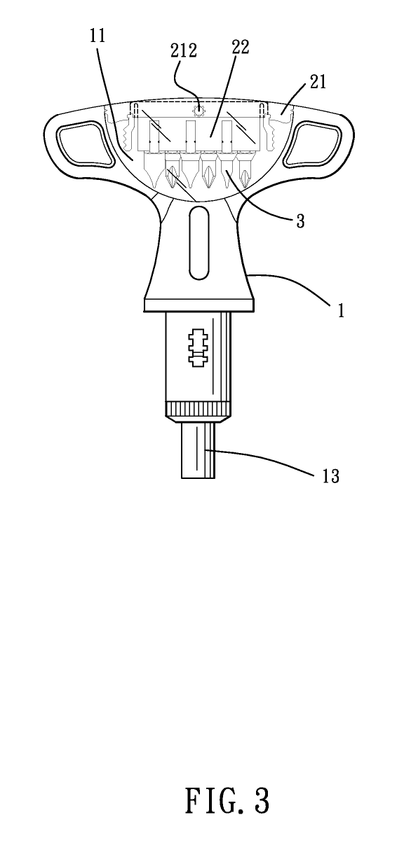

Referring to the drawings and initially to FIGS. 1-3, a tool handle in accordance with the present invention comprises a handle 1 and a tool bit receiving assembly 2 received in the handle 1.

The handle 1 is in T-shaped. The handle 1 has a driving end 13 disposed in one end thereof. The handle 1 has a receiving space 11 defined therein and opposite to the driving end 13 for receiving the tool bit receiving assembly 2. The handle 1 has two pivotal holes 12 respectively defined in a lateral of the receiving space 11 and extended therethrough. A partial peripheral of the handle 1 corresponding to the receiving space 11 is transparent.

The tool bit receiving assembly 2 is provided to place multiple tool bits 3. The tool bit receiving assembly 2 includes a cover 21 and a base 22 connected to the cover 21. One side of the cover 21 is a smooth surface corresponding to the outer surface of the handle 1. The other side of the cover 21 has a concave receiving recess 211 for partially receiving the base 22. The cover 21 has two protrusions 212 respectively extended from a lateral thereof. Each protrusion 212 engages one of the pivotal holes 12 such that the cover 21 rotates relative to the two pivotal holes 12. The base 22 is in a shape of rectangle and has a flat bottom such that the base 22 is steadily placed in any platform. The base 22 has multiple plug recesses 221 defined therein for receiving the multiple tool bits 3.

The tool bit receiving assembly 2 further comprises an engaging portion 4 disposed between the cover 21 and the base 22. The cover 21 has two engaging recesses 43 respectively defined in a lateral of the receiving recess 211. The base 22 has two resilient arms 41 respectively extended from a lateral thereof. Each resilient arm 41 has an engaging protrusion 42 extended therefrom and corresponding to one of the two engaging recesses 43. When each engaging protrusion 42 engages with the corresponding engaging recess 43, the base 22 is firmly connected to the cover 21. Each resilient arm 41 has a pressable end 411 defined in one end thereof and opposite to the engaging protrusion 42. When pressing the pressable ends 411, each engaging protrusion 42 disengages with the corresponding engaging recess 43 such that the base 22 is detached from the cover 21.

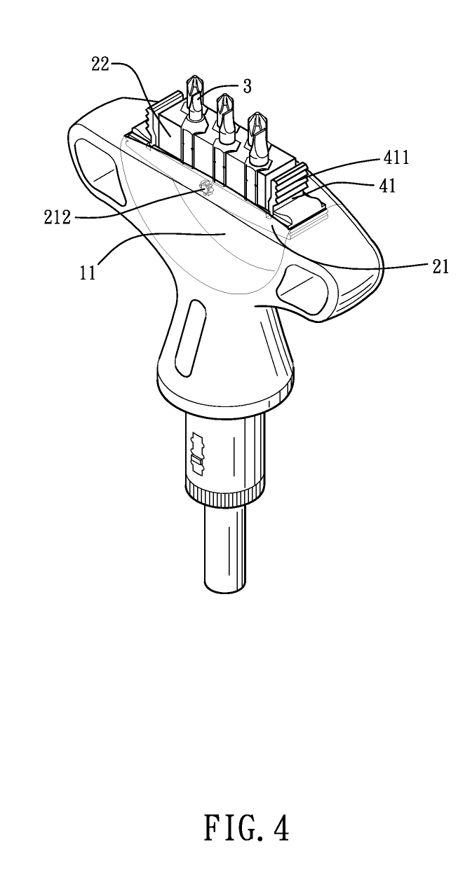

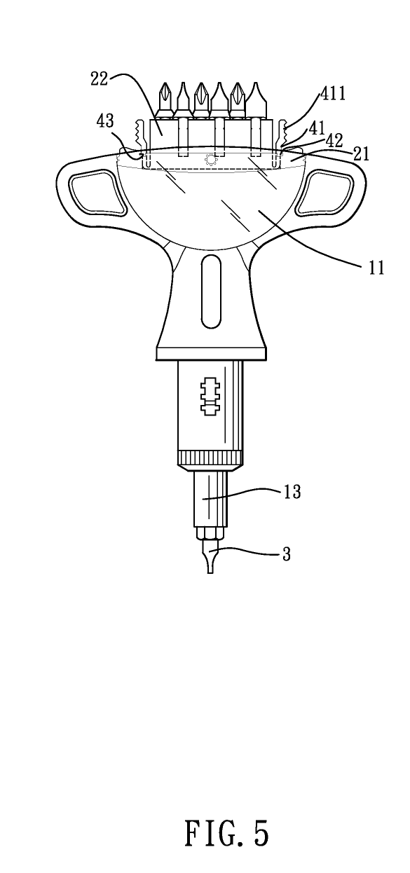

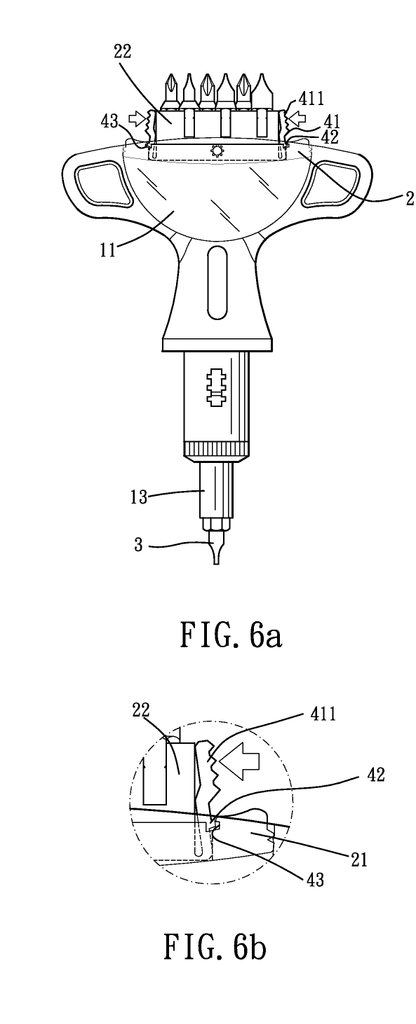

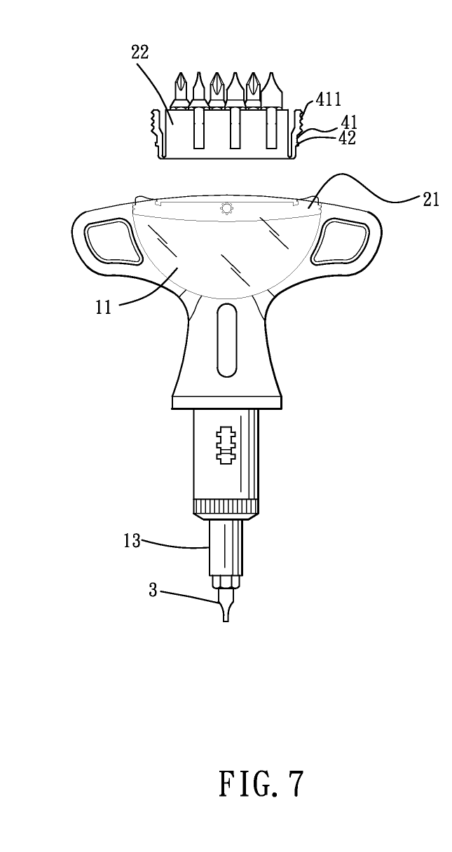

Referring to FIGS. 4-7, the operation of the tool handle in accordance with the present invention is illustrated. When pushing one end of the cover 21, the cover 21 with the base 22 rotates relative to the pivotal holes 12 such that the tool bit receiving assembly 2 is turned over. The multiple tool bits 3 are received in the multiple plug recesses 221. User can pull out one of the multiple tool bits 3 and engage the tool bit 3 with the driving end 13 to fasten/unfasten a screw. When pressing each pressable end 411 of the resilient arm 41, each engaging protrusion 42 disengages with the corresponding engaging recess 43 such that the base 22 is detached from the cover 21. The base 22 with the multiple tool bits 3 can be place in the platform to prevent the tool bits 3 from losing. When necessary, another base 22 with different size/type tool bits 3 is disposed in the receiving recess 211 such that the engaging protrusion 42 engages with the engaging recess 43 to steadily connect the cover 21 and the base 22. When pushing the cover 21 again, the cover 21 with the base 22 rotates relative to the pivotal holes 12 such that the tool bit receiving assembly 2 is received in the receiving space 11 again. The partial outer peripheral of the handle 1 is transparent; therefore, user can see the multiple tool bits 3 inside the receiving space 11 easily.

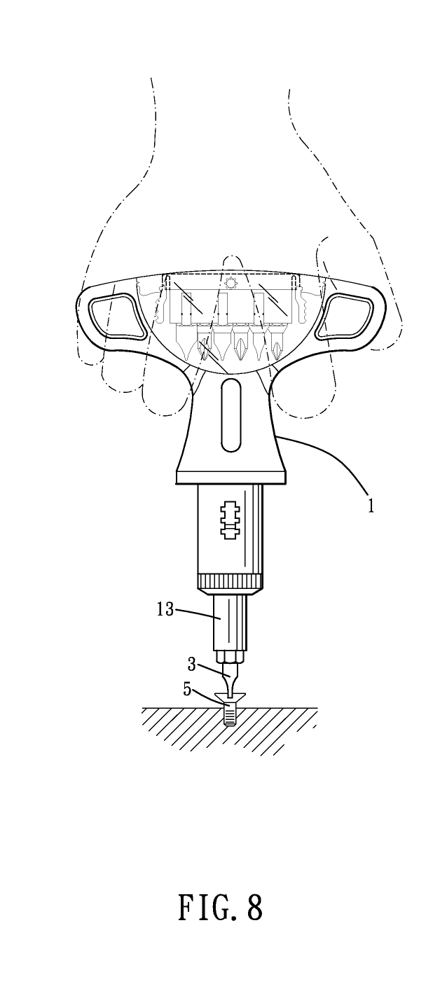

Referring to FIG. 8, the operation of tool handle is illustrated. The driving end 13 engages with the tool bit 3. User can hold the T-shaped handle 1 to screw a fastener 5.

Although the invention has been explained in relation to its preferred embodiment, it is to be understood that many other possible modifications and variations can be made without departing from the spirit and scope of the invention as hereinafter claimed.

What is claimed is:

1. A tool handle comprising:
a handle, the handle having a driving end disposed in one end thereof for adapting to connect to a tool bit, the handle having a receiving space defined in one end thereof and opposite to the driving end; and
a tool bit receiving assembly rotatably received in the receiving space, the tool bit receiving assembly comprising a cover and a base detachably connected to the cover, the base having multiple plug recesses defined therein for receiving multiple tool bits.

2. The tool handle as claimed in claim 1, wherein the cover has a receiving recess defined therein for receiving the base.

3. The tool handle as claimed in claim 2, wherein the cover has two engaging recesses respectively defined in a lateral of the receiving recess, the base having two engaging protrusions respectively extended from a lateral thereof, wherein each engaging protrusion engages with one of the two engaging recesses.

4. The tool handle as claimed in claim 2, wherein the base has two resilient arms respectively extended from a lateral thereof, the cover having two engaging recesses respectively defined in a lateral of the receiving recess, each resilient arm having an engaging protrusion respectively extended therefrom, wherein each engaging protrusion engages with one of the two engaging recesses.

5. The tool handle as claimed in claim 4, wherein each resilient arm has a pressable end disposed in one end thereof and opposite to the engaging protrusion; when pressing the pressable end, each engaging protrusion disengages with the corresponding engaging recess such that the base is detached from the cover.

6. The tool handle as claimed in claim 1, wherein the handle has two pivotal holes respectively defined in a lateral of the receiving space, the cover having two protrusions respectively extended from a lateral thereof, each protrusion engaging one of the two pivotal holes such that the cover is rotatably received in the receiving space.

7. The tool handle as claimed in claim 1, wherein the partial outer peripheral of the handle corresponding to the receiving space is transparent.

8. The tool handle as claimed in claim 1, wherein the handle is a T-shaped handle.
